(19) United States
(12) Patent Application Publication
(10) Pub. No.: US 2008/0008908 A1
(43) Pub. Date: Jan. 10, 2008

(54) Ferromagnetic Film, Magneto-Resistance Element And Magnetic Random Access Memory

(75) Inventors: Nobuyuki Ishiwata, Tokyo (JP); Hiroaki Honjo, Tokyo (JP); Katsuya Nishiyama, Kanagawa (JP); Toshihiko Nagase, Kanagawa (JP)

Correspondence Address: YOUNG & THOMPSON, 745 SOUTH 23RD STREET, 2ND FLOOR, ARLINGTON, VA, 22202, US

(73) Assignee: NEC CORPORATION, Tokyo (JP)

(21) Appl. No.: 11/791,117

(22) PCT Filed: Nov. 9, 2005
(86) PCT No.: PCT/JP05/20539

§ 371 Date: Jun. 22, 2007

(30) Foreign Application Priority Data
Nov. 22, 2004 (JP) 2004-338177
Jun. 16, 2005 (JP) 2005-176819

(51) Int. Cl. G11B 5/39; B32B 15/04

(52) U.S. Cl. 428/811; 428/220; 428/457

(57) ABSTRACT

A ferromagnetic film according to the present invention includes ferromagnetic element and nonmagnetic element and has a first portion and a second portion. Concentration of the nonmagnetic element in the first portion is lower than an average concentration of the nonmagnetic element in the ferromagnetic film. On the other hand, concentration of the nonmagnetic element in the second portion is higher than the average concentration of the nonmagnetic element in the ferromagnetic film. The nonmagnetic element includes at least one element selected from the group consisting of Zr, Ti, Nb, Ta, Hf, Mo and W. The ferromagnetic film is applied to a magnetic free layer of a magneto-resistance element in an MRAM.

### TECHNICAL FIELD

The present invention relates to a magneto-resistance element that exhibits a magneto-resistance effect. In particular, the present invention relates to a ferromagnetic film used in the magneto-resistance element, a method of manufacturing the magneto-resistance element and a magnetic random access memory which uses the magneto-resistance element as a memory cell.

### BACKGROUND ART

A magnetic random access memory (MRAM) is a promising nonvolatile memory from a viewpoint of high integration and high-speed operation. In the MRAM, a magneto-resistance element that exhibits a magneto-resistance effect such as an AMR (Anisotropic Magneto-Resistance) effect, a GMR (Giant Magneto-Resistance) effect or a TMR (Tunnel Magneto-Resistance) effect is utilized. A TMR element exhibiting the TMR effect of them is especially preferable in that a memory cell area can be reduced. In the TMR element, an MTJ (Magnetic Tunnel Junction) in which a tunnel insulating film is sandwiched by at least two magnetic layers is formed.

FIG. 1A and FIG. 1B schematically illustrate an MTJ element having an MTJ. The MTJ element 1 includes a magnetic free layer 2, a magnetic pinned layer 4 and a tunnel insulating film 3 sandwiched between the magnetic free layer 2 and the magnetic pinned layer 4. Each of the magnetic free layer 2 and the magnetic pinned layer 4 includes a ferromagnetic layer having spontaneous magnetization. An orientation of the spontaneous magnetization of the magnetic pinned layer 4 is fixed along a predetermined direction. On the other hand, an orientation of the spontaneous magnetization of the magnetic free layer 2 is reversible and is allowed to be parallel or anti-parallel to the orientation of the spontaneous magnetization of the magnetic pinned layer 4.

FIG. 1A shows a first state where the orientations of the spontaneous magnetization of the magnetic free layer 2 and the magnetic pinned layer 4 are “parallel” to each other, while FIG. 1B shows a second state where the orientations of the spontaneous magnetization of the magnetic free layer 2 and the magnetic pinned layer 4 are “anti-parallel” to each other. It is known that resistance (R+ΔR) of the MTJ element 1 in the second state becomes larger than resistance (R) of the MTJ element 1 in the first state due to the TMR effect. The MR ratio (ΔR/R) of a typical MTJ is in a range from 10% to 50 %. The MRAM uses the MTJ element 1 as a memory cell and nonvolatilely stores data by utilizing the change in the resistance. For example, the first state is assigned to data “0” whereas the second state is assigned to data “1”.

When the data stored in the memory cell is distinguished, the resistance of the MTJ element 1 is detected. More specifically, in a data reading, a predetermined voltage is applied between a bit line 5 connected to the magnetic free layer 2 and a word line 6 connected to the magnetic pinned layer 4. Based on a current value detected at this time, the resistance of the MTJ element 1, namely, the data value (“0” or “1”) stored in the memory cell is distinguished. On the other hand, rewriting data. in the memory cell is performed by reversing the spontaneous magnetization of the magnetic free layer 2. More specifically, respective write currents IWL and IBL are supplied to a write word line and a write bit line that are so provided as to sandwich the MTJ element 1 and intersect with each other. In a case where the write currents IWL and IBL satisfy a predetermined condition, the orientation of the spontaneous magnetization of the magnetic free layer 2 is reversed. due to an external magnetic field generated by the write currents.

FIG. 2A is a graph showing the predetermined condition. A curve shown in FIG. 2A is called an asteroid curve, and ordinate intercepts and abscissa intercepts of the asteroid curve are expressed as +IX0, −IX0 and +IY0, −IY0, respectively. The asteroid curve represents the minimum currents IWL, IBL required for the reversal of the spontaneous magnetization of the magnetic free layer 2. That is to say, in a case when the currents IWL, IBL corresponding to the outside (Reversal region) of the asteroid curve are supplied, the MTJ element 1 transits from the first state to the second state or from the second state to the first state. Namely, the data value “1” or “0” is written to the memory cell. On the other hand, in a case when the supplied currents IWL, IBL correspond to the inside (Retention region) of the asteroid curve, the data rewriting does not occur.

FIG. 2B is a graph showing a distribution of the above-mentioned asteroid curves with respect to a plurality of memory cells. In the MRAM, the plurality of memory cells are arranged in an array form, and the MTJ elements 1 included in the plurality of memory cells have variation in property. As a result, a group of asteroid curves (curve group) with respect to the plurality of memory cells is distributed between a curve Cmax and a curve Cmin, as shown in FIG. 2B. Here, intercepts of the curve Cmax are expressed as IX(max) and IY(max), and intercepts of the curve Cmin are expressed as IX(min) and IY(min).

Firstly, in order to achieve the writing to each of the plurality of memory cells, the write currents IWL, IBL need to exist in at least the outside (Reversal region) of the curve Cmax. Here, the write currents IWL, IBL have an effect also on memory cells other than a target memory cell. It is necessary to avoid the writing to the non-target memory cells due to a magnetic field generated by any one of the write currents IWL and IBL. Therefore, the current IWL flowing through the write word line needs to be smaller than the IX (min) , and the current IBL flowing through the write bit line needs to be smaller than the IY (min) That is to say, the write currents IWL, IBEL need to correspond to a hatching region (write margin) shown in FIG. 2B. The write margin becomes smaller, as the variation in the property of the MTJ elements 1 becomes larger.

It is desirable to design the write margin larger in order to improve operation property of the MRAM. In order to make the write margin larger, it is desirable to reduce the variation in the property of the MTJ elements 1, namely, the variation in the external field (referred to as a “switching magnetic field” hereinafter) required for reversing the spontaneous magnetization of the magnetic free layer 2.

Also, the followings are known as common techniques relating to the magneto-resistance element.

Japanese Laid-Open Patent Application JP-Heisei-07-58375 discloses a “granular magneto-resistance film” applied to a magnetic transducer (head) which scans information signals recorded on a magnetic medium. In the granular magneto-resistance film, discontinuous layers of ferromagnetic material are. embedded in a layer of nonmagnetic conductive material. The ferromagnetic material is selected from the group consisting of Fe, Co, Ni and ferromagnetic alloy based on them. The nonmagnetic conductive material is selected from the group consisting of Ag, Au, Cu, Pd, Rh and alloy based on them.

Japanese Laid-Open Patent Application JP-Heisei-08-67966 discloses a “magneto-resistance effect film” applied to a magnetic sensor which scans information signals recorded on a magnetic medium. An object of the related art is to provide a magneto-resistance effect film in which 'the resistance changes greatly with a small magnetic field, thermostability is excellent and hysteresis is small. In the magneto-resistance effect film, nonmagnetic metal and magnetic metal are phase-separated. The structure is formed by deposition of granular magnetic metal in a nonmagnetic metal base-material through heat treatment (granular film). Here, the nonmagnetic metal is either of Ag, Au or Cu.

Japanese Laid-Open Patent Application JP-2003-60172 discloses a “magnetic memory element”. An object of the related art is to reduce the write current without deteriorating reliability and to prevent electromigration-induced breaking. In the magnetic memory element, a write interconnection generating a magnetic field for writing has a compound structure of a conductive layer made of nonmagnetic conductive material and a magnetic layer made of soft magnetic material with high permeability. The magnetic layer has a specific resistance equal to or more than four times that of the conductive layer. Moreover, the magnetic layer consists of Fe, Co, Ni or alloy of them, and contains at least one element of B, C, Al, Si, P, Ti, V, Cr, Zr, Nb, Mo, Hf, Ta, W and Y more than 0.5 at %.

### DISCLOSURE OF INVENTION

Through calculations and experiments, the inventors have found that irregularity of the magnetic free layer is one of causes of the variation in the switching magnetic field. Therefore, to improve evenness of the magnetic free layer is effective for reducing the variation in the switching magnetic field. For the purpose of improving the evenness of the magnetic free layer, for example, it can be considered to use a CoFeB film or a NiFe film as the magnetic free layer 2. The CoFeB film is amorphous and thus effective for suppressing the occurrence of irregularity. However, the element B diffuses due to a high-temperature process at the time of manufacturing a device, which deteriorates its property, particularly reduces the MR ratio. In order to prevent the property variation with time, it is desirable to basically use a crystalline film as the magnetic free layer. The NiFe film is crystalline and may be promising. However, it has limitations as to suppression of occurrence of the irregularity accompanying crystal growth. A technique that further improves evenness of the magnetic free layer is desired.

Therefore, an object of the present invention is to provide a ferromagnetic film having excellent evenness.

Another object of the present invention is to provide a magneto-resistance element which can reduce the variation in the switching magnetic field, a method of manufacturing thereof and an MRAM utilizing the magneto-resistance element.

The inventors of the present application have found that a ferromagnetic film having excellent evenness and thermotolerance can be produced by forming a film including at least one element (first element) of Fe, Co and Ni and at least one element (second element) of Zr, Ti, Nb, Ta, Hf, Mo and W and then heat treating the film. It has been found that a first portion and a second portion are formed in the ferromagnetic film due to the heat treatment. Concentration of the second element in the first portion is lower than an average concentration of the second element in the ferromagnetic film, while concentration of the second element in the second portion is higher than the average concentration. Moreover, it has been found that when the temperature of the heat treatment is set to be further higher, a ferromagnetic portion whose principal constituent is the first element and a non-ferromagnetic portion consisting of the second element are formed and phase separated in the ferromagnetic film. The inventors of the present application have found that the structures thus formed contribute to the excellent evenness and thermotolerance. Moreover, the inventors of the present application have found that the variation in the switching magnetic field can be reduced by using such the ferromagnetic film as a magnetic free layer of an MRAM.

In a first aspect of the present invention, a ferromagnetic film is provided. A ferromagnetic film according to the present invention includes ferromagnetic element and nonmagnetic element and has a first portion and a second portion. Concentration of the nonmagnetic element in the first portion is lower than an average concentration of the nonmagnetic element in the ferromagnetic film, while concentration of the nonmagnetic element in the second portion is higher than the average concentration. The ferromagnetic element includes at least one element selected from the group consisting of Fe, Co and Ni. Also, the nonmagnetic element includes at least one element selected from the group consisting of Zr, Ti, Nb, Ta, Hf, Mo and w. The ferromagnetic film can be crystalline, and the second portion can exist at a grain boundary. The first portion can be formed to have a column structure. The concentration of each element may change gradually at a boundary between the first portion and the second portion. It is preferable that the ferromagnetic film has a thickness of 1 to 20 nm.

A ferromagnetic film according to the present invention can include a ferromagnetic portion and a non-ferromagnetic portion that are phase separated. The ferromagnetic portion includes at least one element selected from the group consisting of Fe, Co and Ni as principal constituent. Also, the non-ferromagnetic portion includes at least one element selected from the group consisting of Zr, Ti, Nb, Ta, Hf, Mo and W which are nonmagnetic elements. Concentration of each element may change gradually at a boundary between the ferromagnetic portion and the non-ferromagnetic portion that are phase separated. The ferromagnetic portion can be crystalline, and the non-ferromagnetic portion can exist at a grain boundary of the ferromagnetic portion. The ferromagnetic portion can be formed to have a columnar structure. It is preferable that the ferromagnetic film has a thickness of 1 to 20 nm.

It is preferable that an atomic percent of the average concentration of the nonmagnetic element in the ferromagnetic film is lower than 30%. It is also preferable that the atomic percent of the average concentration of the nonmagnetic element in the ferromagnetic film is higher than 5%. In this case, the evenness of the ferromagnetic film is greatly improved., and a roughness average of the surface is equal to or less than 0.3 nm.

A ferromagnetic film according to the present invention can include; at least one first element selected from the group consisting of Fe, Co and Ni; and at least one second element selected from the group consisting of Zr, Ti, Nb, Ta, Hf, Mo and W. A lattice constant of the ferromagnetic film is smaller than a lattice constant of an alloy in which the first element and the second element are distributed homogeneously. The lattice constant is a value obtained from a peak position of an X-ray diffraction measurement or an electron diffraction pattern.

In a second aspect of the present invention, a magneto-resistance element is provided. A magneto-resistance element according to the present invention has: a magnetic free layer including the above-described ferromagnetic film; a magnetic pinned layer; and a nonmagnetic layer sandwiched between the magnetic free layer and the magnetic pinned layer. A magneto-resistance element according to the present invention has: a magnetic free layer; a magnetic pinned layer; and a nonmagnetic layer sandwiched between the magnetic free layer and. the magnetic pinned layer. The magnetic free layer has a ferromagnetic film including ferromagnetic element and nonmagnetic element, and the ferromagnetic film includes a first portion in which concentration of the nonmagnetic element is lower and a second portion in which concentration of the nonmagnetic element is higher as compared with an average concentration of the nonmagnetic element in the ferromagnetic film. Alternatively, the magnetic free layer includes a ferromagnetic portion and a non-ferromagnetic portion that are phase separated. The nonmagnetic layer is a tunnel insulating film through which a tunnel current passes.

In a third aspect of the present invention, a magnetic random access memory is provided. The magnetic random access memory has the above-described magneto-resistance element. As a result, the variation in the switching magnetic field is reduced. Therefore, the operation margin is improved and the yield is improved.

In a fourth aspect of the present invention, a method of manufacturing a magneto-resistance effect stacked film is provided. The manufacturing method includes: (A) a process of forming a magnetic pinned layer; (B) a process of forming a nonmagnetic layer on the magnetic pinned layer; (C) a process of forming on the nonmagnetic layer a magnetic free layer that includes a first element that is ferromagnetic and a second element that is non-ferromagnetic; and (D) a process of performing a heat treatment. In the (D) process, the heat treatment is performed such that a first portion in which concentration of the second element is lower and a second portion in which concentration of the second element is higher are formed. Alternatively, the heat treatment is performed such that a ferromagnetic portion including the first element as principal constituent and a non-ferromagnetic portion consisting of the second element are phase separated. In the (D) process, the heat treatment is preferably performed under a temperature of 270 degrees centigrade or higher. The inventors of the present application have found that it is preferable to use at least one element selected from the group consisting of Zr, Ti, Nb, Ta, Hf, Mo and W as the second element.

According to the present invention, a ferromagnetic film having excellent evenness is provided. Also, according to the present invention, a ferromagnetic film having excellent high thermotolerance is provided.

Also, according to a magneto-resistance element and an MRAM of the present invention, the variation in the switching magnetic field is reduced and an operation margin is improved.

Also, according to a magneto-resistance element and an MRAM of the present invention, the yield is improved.

### BRIEF DESCRIPTION OF DRAWINGS

FIG. 1A is a schematic diagram illustrating a configuration of a typical MTJ element;

FIG. 1B is a schematic diagram illustrating a configuration of a typical MTJ element;

FIG. 2A is a graph showing an asteroid curve with respect to a certain memory cell;

FIG. 2B is a graph showing a distribution of asteroid curves with respect to a plurality of memory cells;

FIG. 3 is a schematic diagram showing a configuration of a magneto-resistance element (TMR element) according to the present. invention;

FIG. 4A is a schematic view showing a cross-sectional structure of a magnetic free layer according to the present invention;

FIG. 4B is a schematic view showing a cross-sectional structure of a magnetic free layer according to the present invention;

FIG. 5 is a graph showing Zr contents dependence of “magnetization” of a NiFeZr film according to the present invention;

FIG. 6 is a graph showing Zr contents dependence of “surface roughness” of a NiFeZr film according to the present invention;

FIG. 7 is a graph showing Zr contents dependence of “average grain size” of a NiFeZr film according to the present invention;

FIG. 8 is a graph showing Zr contents dependence of “average grain size” of a NiFeRh film according to a comparative example;

FIG. 9 is a schematic diagram showing a configuration of an MRAM according to the present invention;

FIG. 10 is a table showing variations in switching magnetic field of the MRAM according to the present invention, with respect to a plurality of examples; and

FIG. 11 is a graph showing Zr contents dependence of “X-ray diffraction peak” of a NiFeZr film according to the present invention.

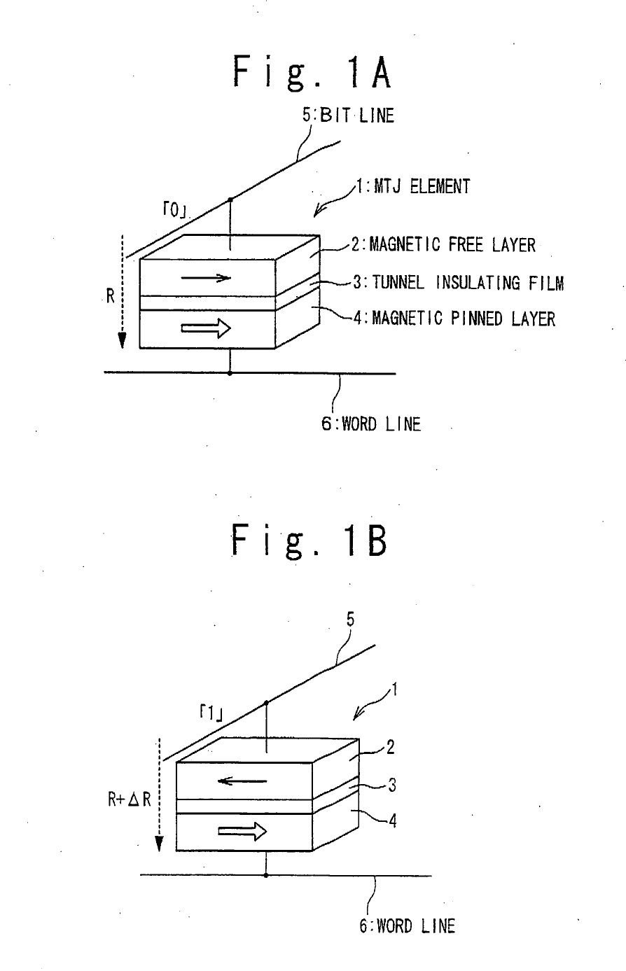

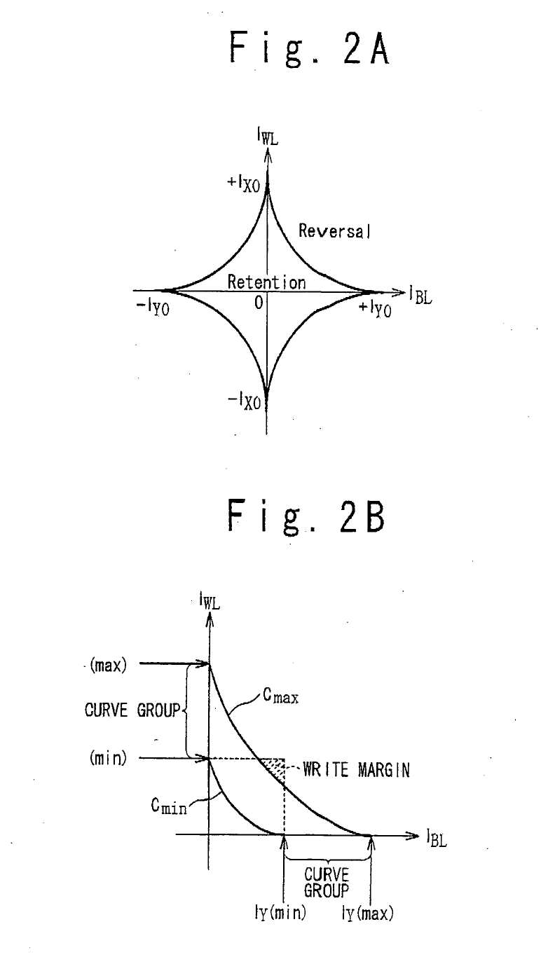

### BEST MODE FOR CARRYING OUT THE INVENTION

A ferromagnetic film, a magneto-resistance element, a magnetic random access memory and a method of manufacturing a magneto-resistance effect stacked film according to the present invention will be exemplified with reference to the attached drawings.

(Structure)

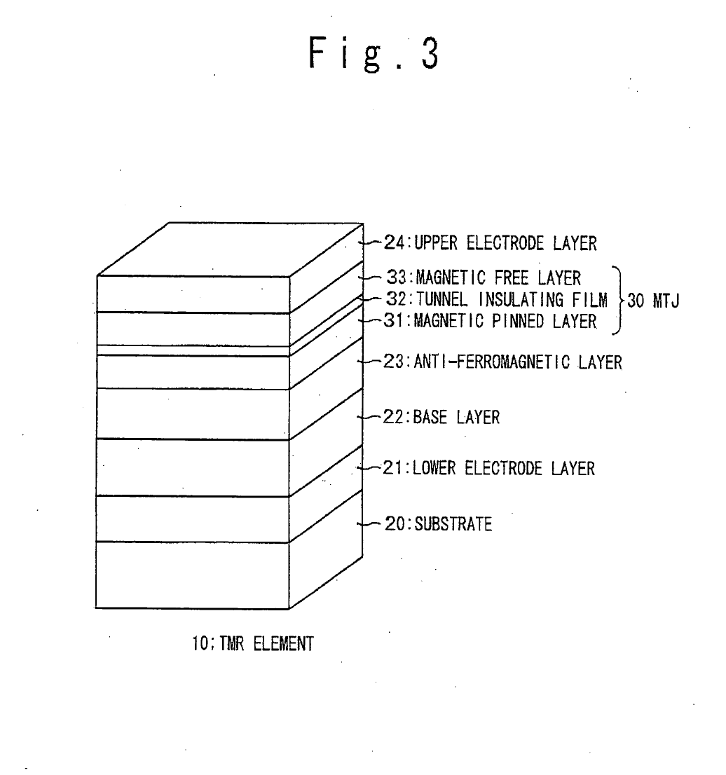

FIG. 3 shows a structure of a magneto-resistance element (magneto-resistance effect stacked film) according to the present invention. For example, FIG. 3 shows a structure of a TMR element 10 that exhibits the TMR effect. The TMR element 10 includes a substrate 20, a lower electrode layer 21, a base layer 22, an anti-ferromagnetic layer 23, an upper electrode layer 24 and an MTJ 30. In FIG. 3, the lower electrode layer 21 is formed on the substrate 20 and is connected to the MTJ 30 through the base layer 22 and the anti-ferromagnetic layer 23. Also, the upper electrode layer 24 is connected to the MTJ 30.

The MTJ 30 includes a magnetic pinned layer 31, a tunnel insulating film 32 and a magnetic free layer 33. The magnetic pinned layer 31 is formed on the anti-ferromagnetic layer 23, and the upper electrode layer 24 is formed on the magnetic free layer 33. The tunnel insulating film 32 is formed to be sandwiched between the magnetic pinned layer 31 and the magnetic free layer 33. The magnetic pinned layer 31 and the magnetic free layer 33 are “ferromagnetic layers” including ferromagnetic and have spontaneous magnetization. An orientation of the spontaneous magnetization of the magnetic pinned layer (pinned layer) 31 is fixed along a predetermined direction. An orientation of the spontaneous magnetization of the magnetic free layer (free layer) 33 is reversible and is allowed to be parallel or anti-parallel to the orientation of the spontaneous magnetization of the magnetic pinned layer 31. On the other hand, the tunnel insulating film 32 is a “nonmagnetic layer”. The tunnel insulating film 32 is formed to be thin enough to allow passage of a tunnel current.

As described above, the TMR element 10 has a structure that a plurality of layers including the MTJ layer 30 exhibiting the tunnel magneto-resistance (TMR) effect are stacked. The base layer 22 is composed of, for example, Ta, and its thickness is, for example, 20 nm. The anti-ferromagnetic layer 23 is composed of, for example, PtMn, and its thickness is, for example, 15 nm. The upper electrode layer 24 is composed of, for example, Ta, and its thickness is, for example, 5 nm. The magnetic pinned layer 31 is composed of, for example, a CoFe film with a thickness of 2.5 nm, a Ru film with a thickness of 0.8 nm formed thereon, and a CoFe film with a thickness of 2.5 nm formed thereon. The tunnel insulating film 32 is composed of, for example, AlO, and its thickness is, for example, 1 nm. A thickness of the magnetic free layer 33 is, for example, 5 nm. Materials of the magnetic free layer 33 according to the present invention will be described below.

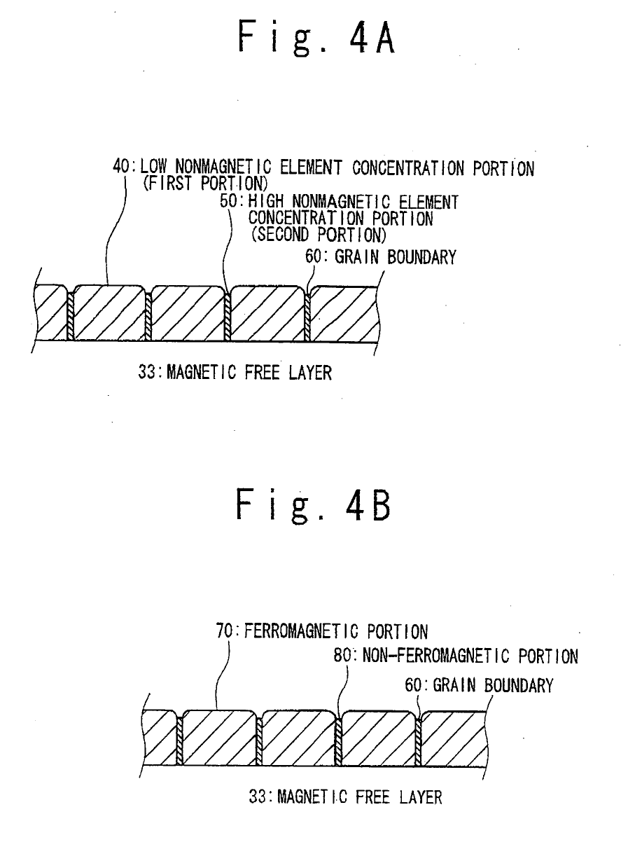

Each of FIG. 4A and FIG. 4B is a view schematically exemplifying a cross-section of the magnetic free layer (ferromagnetic film) 33 according to the present invention. In FIG. 4A, a magnetic free layer 33 includes a first portion 40 in which concentration of nonmagnetic element is low and a second portion 50 in which concentration of nonmagnetic element is high. The concentration of nonmagnetic element in the first portion 40 is lower than an average concentration of nonmagnetic element in the ferromagnetic film 33, while the concentration of nonmagnetic element in the second portion 50 is higher than the average concentration. The ferromagnetic film 33 is crystalline, and the second portion 60 exists at a grain boundary 60. The ferromagnetic element includes at least one element selected from the group consisting of Fe, Co and Ni. On the other hand, the nonmagnetic element includes at least one element selected from the group consisting of Ti (titanium) , Zr (zirconium) , Nb (niobium) , Hf (hafnium) Ta (tantalum), Mo (molybdenum) and W(tungsten). Also, the concentration of the nonmagnetic element can change continuously at a boundary between the first portion 40 and the second portion 50.

In FIG. 4B, a magnetic free layer (ferromagnetic film) 33 includes a ferromagnetic portion 70 that exhibits ferromagnetic property and a non-ferromagnetic portion 80 that does not exhibit ferromagnetic property. The ferromagnetic portion 70 includes at least one element selected from the group consisting of Fe, Co and Ni as “principal constituent”. On the other hand, the non-ferromagnetic portion 80 includes at least one element selected from the group consisting of Ti, Zr, Nb, Hf, Ta, Mo and W. The ferromagnetic portion 70 and the non-ferromagnetic portion 80 are phase separated. The ferromagnetic portion 70 is crystalline, and the non-ferromagnetic portion 80 exists at a grain boundary 60. The structure shown in FIG. 4B can be obtained by heat treating under a higher temperature as compared with that in FIG. 4A. Also, the concentration of the nonmagnetic element can change continuously at a boundary between the ferromagnetic portion 70 and the non-ferromagnetic portion 80.

The fact that the ferromagnetic film 33 includes the above-mentioned first portion 40 and the second portion 50, or the fact that the above-mentioned ferromagnetic portion 70 and the non-ferromagnetic portion 80 are phase separated brings about the following effects. In general, during a production process of an MRAM, various heat treatments are performed after a ferromagnetic film is formed. For example, a heat treatment under a temperature of about 350 degrees centigrade is performed in an interconnection formation process after a ferromagnetic film is formed. Even if crystal grain is small immediately after the film is formed, the crystal grain grows due to such the heat treatment and thus the evenness of the eventual ferromagnetic film is deteriorated. However, according to the ferromagnetic film 33 of the present invention, the second portion 50 existing at the grain boundary 60 suppresses the grain growth in the first portion 40 in which the concentration of the nonmagnetic element is low. Alternatively, the non-ferromagnetic portion 80 existing at the grain boundary 60 suppresses the grain growth in the ferromagnetic portion 70 (NiFe for example) Since foreign material is deposited at the grain boundary 60, the crystal grain in the first portion 40 or the ferromagnetic portion 70 is hard to grow thermally. That is to say, the thermotolerance is improved and thus the evenness of the generated ferromagnetic film is improved. In other words, the irregularity on the surface of the magnetic free layer 33 is suppressed.

Moreover, as shown in FIG. 4A and FIG. 4B, the first portion 40 or the ferromagnetic portion 70 has a columnar structure. Since the columnar first portion 40 is surrounded by the second portion 50, it is prevented that the grain size becomes larger due to the heat treatment or the like. Also, since the columnar ferromagnetic portion 70 is surrounded by the non-ferromagnetic portion 80, it is prevented that the grain size becomes larger due to the heat treatment or the like. The growth of the crystal grain in the first portion 40 or the ferromagnetic portion 70 is suppressed, and thus the evenness of the generated ferromagnetic film is improved. In order that the columnar structure is formed, it is preferable that the thickness of the ferromagnetic film (magnetic free layer 33) is 1 to 20 nm. In order that the film functions as the magnetic free layer 33, a certain amount of thickness is necessary. If the thickness is too much to the contrary, the spontaneous magnetization becomes hard to reverse. Therefore, it is particularly preferable that the thickness of the magnetic free layer 33 is 2 to 10 nm.

Hereinafter, a more detailed discussion will be given on the composition of the ferromagnetic film (magnetic free layer) 33 according to the present invention. Here, the discussion will be given with reference to a “NiFeZr film” as an example. In this case, NiFe is used as the ferromagnetic element and Zr is used as the nonmagnetic element. Concentration of Zr in the first portion 40 is lower than an average concentration of Zr in the ferromagnetic film 33, while concentration of Zr in the second portion 50 is higher than the average concentration.

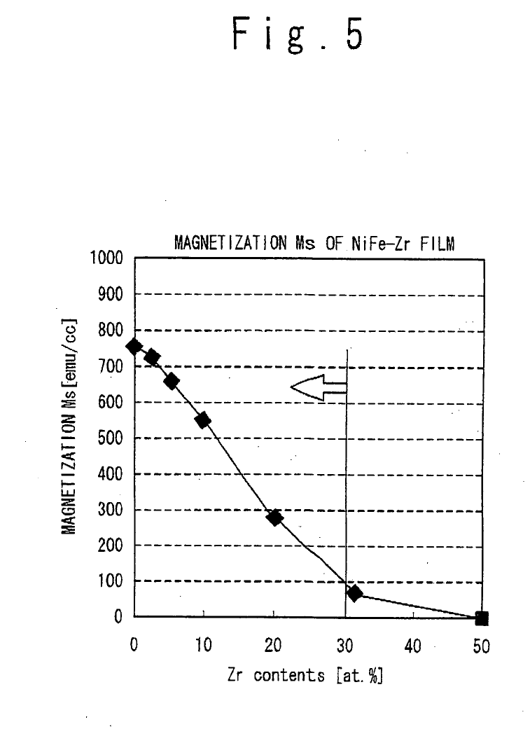

FIG. 5 is a graph showing Zr contents dependence of “magnetization Ms” of the NiFeZr film according to the present invention. In FIG. 5, the ordinate axis represents the magnetization Ms and the abscissa axis represents the Zr contents (unit: atomic percent (%) Here, the Zr contents means contents of Zr with respect to the whole of the film (the first portion 40+the second portion 50). As shown in FIG. 5, the magnetization Ms has a tendency to decrease as the Zr contents increases. Especially, if the Zr contents excesses “30 atomic %” the magnetization Ms becomes very small or disappears. It is therefore desirable that the Zr contents is lower than “30 atomic %” in order that the film functions as the magnetic free layer 33. particularly preferable that the thickness of the magnetic free layer 33 is 2 to 10 nm.

Hereinafter, a more detailed discussion will be given on the composition of the ferromagnetic film (magnetic free layer) 33 according to the present invention. Here, the discussion will be given with reference to a “NiFeZr film” as an example. In this case, NiFe is used as the ferromagnetic element and Zr is used as the nonmagnetic element. Concentration of Zr in the first portion 40 is lower than an average concentration of Zr in the ferromagnetic film 33, while concentration of Zr in the second portion 50 is higher than the average concentration.

FIG. 5 is a graph showing Zr contents dependence of “magnetization Ms” of the NiFeZr film according to the present invention. In FIG. 5, the ordinate axis represents the magnetization Ms and the abscissa axis represents the Zr contents (unit: atomic percent (%) Here, the Zr contents means contents of Zr with respect to the whole of the film (the first portion 40+the second portion 50). As shown in FIG. 5, the magnetization Ms has a tendency to decrease as the Zr contents increases. Especially, if the Zr contents excesses “30 atomic %” the magnetization Ms becomes very small or disappears. It is therefore desirable that the Zr contents is lower than “30 atomic %” in order that the film functions as the magnetic free layer 33.

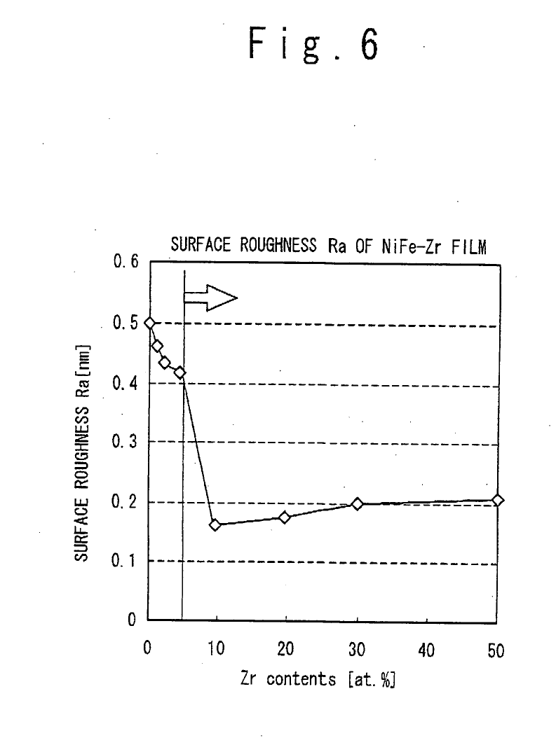

FIG. 6 is a graph showing Zr contents dependence of “surface roughness Ra” of the NiFeZr film according to the present invention. Here, the surface roughness Ra is defined by the roughness average of a surface of the generated film, and is obtained by an observation with the use of an AFM (Atomic Force Microscope) . In FIG. 6, the ordinate axis represents the surface roughness Ra and the abscissa axis represents the Zr contents (unit: atomic percent). Here, the Zr contents means contents of Zr with respect to the whole of the film (the first portion 40 +the second portion 50). As shown in FIG. 6, the surface roughness Ra varies much depending on the Zr contents. In particular, the inventors of the present application have found that the surface roughness Ra decreases conspicuously when the Zr contents excesses “5 atomic %”. Also, it is preferable that the surface roughness Ra is equal to or less than 0.3 nm. As a result, the evenness of the generated film is improved greatly.

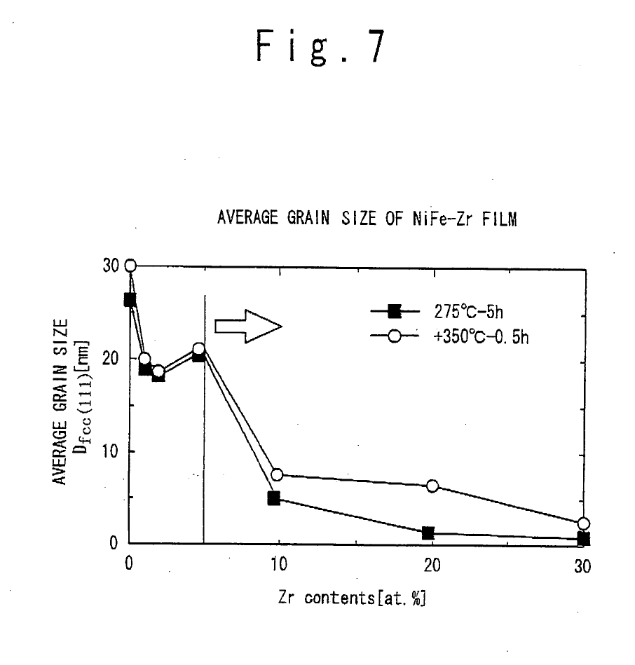

FIG. 7 is a graph showing Zr contents dependence of “average grain size Dfcc” of the NiFeZr film according to the present invention. The average grain size Dfcc can be calculated by a well-known method from the full width at half maximum (FWHM) of an X-ray diffractionpeak. There is a tendency that the average grain size Dfcc is smaller as the FWHM is larger whereas the average grain size Dfcc is larger as the FWHM is smaller. It should be noted in the present example that what appears by the X-ray diffraction is mainly a pattern associated with NiFe and the calculated average grain size Dfcc represents the average grain size of NiFe. In FIG. 7, the ordinate axis represents the average grain size Dfcc and the abscissa axis represents the Zr contents (unit; atomic percent) Here, the Zr contents means contents of Zr with respect to the whole of the film (the first portion 40+the second portion 50). Also, squares in the graph denote a case where the heat treatment under 275 degrees centigrade is performed for five hours immediately after the film is formed, while circles in the graph denote a case where the heat treatment under 350 degrees centigrade is performed for half an hour immediately after the film is formed.

As shown in FIG. 7, the average grain size Dfcc varies much depending on the Zr contents. More specifically, there is a tendency that the average grain size decreases as the Zr contents increases. That is to say, the crystal grain becomes smaller in the case of NiFe crystal into which Zr is introduced, as compared with a case of pure NiFe crystal. In particular, the inventors of the present application have found that the average grain size Dfcc decreases conspicuously (micro-crystallization) when the Zr contents excesses “5 atomic %”. The decrease in the average grain size means that the irregularity of the generated film is suppressed. It is therefore desirable that the Zr contents is higher than “5 atomic %”.

In the present invention, the nonmagnetic element is not limited to Zr. As described above, the nonmagnetic element is at least one element selected from Ti (titanium) , Zr (zirconium), Nb (niobium) , Hf (hafnium), Ta (tantalum), Mo (molybdenum) and W (tungsten). The inventors first have found that the evenness of the generated film is improved by using such materials, as in the case of Zr.

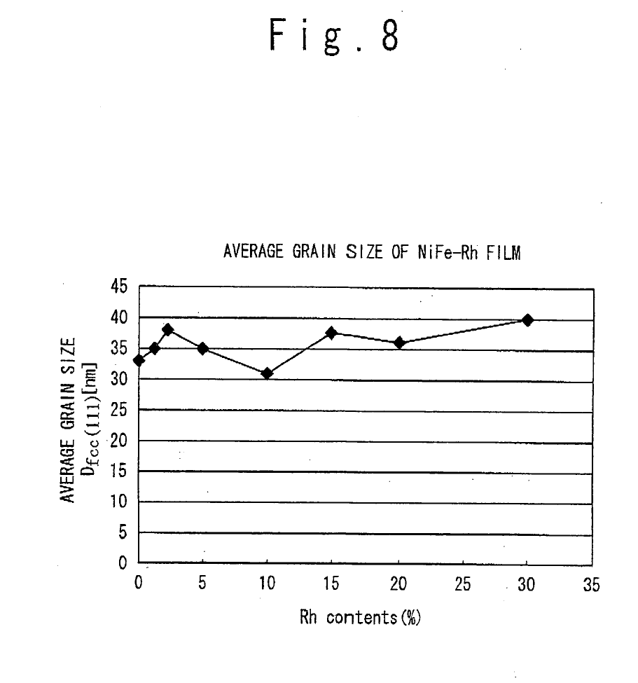

FIG. 8 shows Rh contents dependence of average grain size of a NiFeRh film, as a comparative example. The Rh (rhodium) is a material disclosed in the above-mentioned patent document (Japanese Laid-Open Patent Application JP-Heisei-07-558375) . In FIG. 8, the ordinate axis represents the average grain size Dfcc and the abscissa axis represents the Rh contents (unit; atomic percent). Here, the Rh contents means contents of Rh with respect to the whole of the film. As shown in FIG. 8, the average grain size Dfcc does not decrease even in the Rh contents is increased. That is to say, it is made clear that NiFe does not micro-crystallize when Rh is used. In other words, it is made clear that the evenness of the generated film is not improved.

It is considered that one reason for the result shown in FIG. 8 is that an atomic radius (0.134 nm) of rhodium (Rh) is smaller than an atomic radius (0.162 nm). of zirconium (Zr). In order to interfere the growth of the Fe, Co, Ni crystal grain in the first portion 40, it is preferable that the atomic radius of the nonmagnetic element is larger. As compared with an atomic radius (about 0.125 nm) of Fe, Co and Ni, the atomic radius of the nonmagnetic element according to the present invention is larger: Ti (0.147 nm), Zr (0.162 nm), Nb (0.143 nm), Hf (0.160 nm), Ta (0.143 nm), Mo (0.136 nm) and W (0.137 nm). It has been confirmed that the micro-crystallization occurs by using such elements. Especially, Zr andHf among those elements have relatively large atomic radii, which are preferable.

Also, it has been confirmed that the structure in which the first portion 40 and the second portion 50 are separated from each other is formed through the heat treatment in the case where those elements are used. As described above, the high thermotolerance can be achieved by the separation structure. A temperature of 270 degrees centigrade or higher is preferable as the heat treatment temperature. When the heat treatment temperature becomes higher, the separation of the low nonmagnetic element concentration portion 40 and the high nonmagnetic element concentration portion 50 further progresses, and thereby the structure shown in FIG. 4B in which. the non-ferromagnetic portion 80 that does not exhibit the ferromagnetic property is separated from the ferromagnetic portion 70 that exhibits the ferromagnetic property is obtained. Also, in order to prevent property change during a high-temperature process of about 350 degrees centigrade, the nonmagnetic element deposited at the grain boundary 60 is preferably high melting point metal. In accordance with the above-described points of view and experimental results, Ti, Zr, Nb, Hf, Ta, Mo and W are selected as the nonmagnetic metal in the present invention.

According to the present invention, as described above, the growth of the crystal grain in the first portion 40 in which the concentration of the nonmagnetic element is low or in the ferromagnetic portion 70 is suppressed. As compared with the conventional technique, the size of the crystal grain becomes smaller. As a result, the evenness of the generated ferromagnetic film is improved. Such the ferromagnetic film is preferably applied to the magnetic free layer 33 in the TMR element 10 (refer to FIG. 3). As a result, the occurrence of the irregularity on the surface of the magnetic free layer 33 is suppressed and the evenness is improved. It is also desirable to apply the TMR element 10 including such the magnetic free layer 33 to a magnetic random access memory (MRAM). Consequently, the variation in the switching magnetic field is reduced in an operation of the MRAM. That is to say, the operation margin is improved and the switching characteristics are improved. Moreover, the yield is improved.

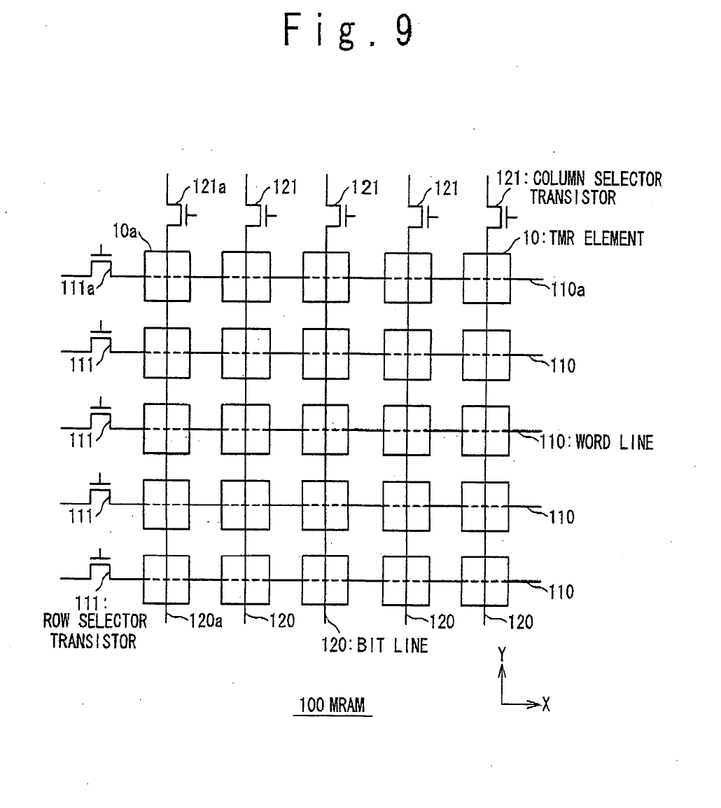

FIG. 9 is a schematic diagram showing a configuration of an MRAM provided with the TMR element (magneto-resistance element) 10 according to the present invention. The MRAM 100 is provided with a plurality of word lines 110 extending in an X-direction and a plurality of bit lines 120 extending in a Y-direction. The plurality of word lines 110 and the plurality of bit lines 120 are so arranged as to intersect with each other, and a memory cell is provided at each intersection. That is to say, a plurality of memory cells are arranged in an array form. Each memory cell includes the above-described TMR element 10.

Also, each memory cell (TMR element 10) is so provided as to be sandwiched between one word line 110 and one bit line 120. Respective word lines 110 are connected to row selector transistors 111 and respective bit lines 120 are connected to column selector transistors 121. When a memory cell 10a is selected, a row selector transistor llla and a column selector transistor 121a are turned ON and hence the corresponding word line 110a and bit line 120a are activated. Then, predetermined write currents are supplied to the word line 110a and the bit line 120a, respectively, and thereby the data is written to the selected memory cell 10a.

Since the MRAM 100 has the plurality of memory cells (TMR elements) 107 there is variation in the switching magnetic field at the time of the writing operation. The variation in the switching magnetic field is correlated to the surface roughness Ra. The inventors have manufactured a plurality of MRAMs 100 respective including the magnetic free layers 33 with different compositions by way of trial and measured respective variations in the switching magnetic field (reversal magnetic field).

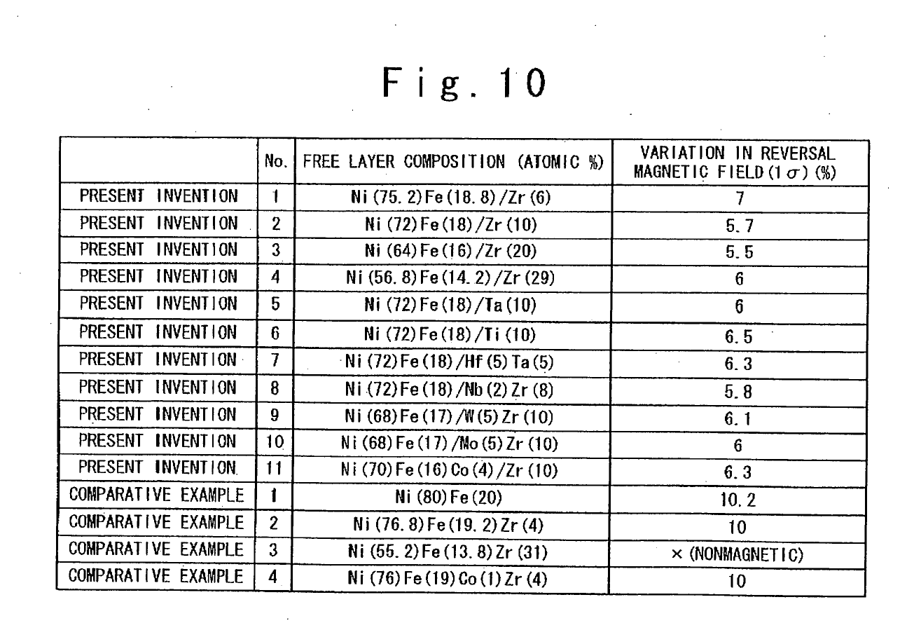

FIG. 10 shows the experimental results, Specifically, the composition of the magnetic free layer (free layer) 33 and the measured variation (la) in the switching magnetic field (reversal magnetic field) are shown with respect to the plurality of MRAMs. In the column “free layer composition”, a number in parentheses indicates the atomic percent. Also, the thickness of the magnetic free layer 33 is 5 nm. The base layer 22 is a Ta filmwith a thickness of 20 nm. The anti-ferromagnetic layer 23 is a PtMn film with a thickness of 15 nm. The magnetic pinned layer 31 is composed of a CoFe film with a thickness of 2.5 nm, a Ru film with a thickness of 0.8 nm and a CoFe film with a thickness of 2.5 nm. The tunnel insulating film 32 is an AlO film with a thickness of 1 nm. The upper electrode layer 24 is a Ta film with a thickness of 5 nm.

### EXPERIMENTAL EXAMPLE NO. 1

NiFe is used as the ferromagnetic element and Zr is used as the nonmagnetic element. The Zr contents is “6 atomic %” In this case, the variation σ in the reversal magnetic field is 7.0%.

### EXPERIMENTAL EXAMPLE NO. 2

NiFe is used as the ferromagnetic element and Zr is used as the nonmagnetic element. The Zr contents is “10 atomic %”. In this case, the variation σ in the reversal magnetic field is 5.7%.

### EXPERIMENTAL EXAMPLE NO. 3

NiFe is used as the ferromagnetic element and Zr is used as the nonmagnetic element. The Zr contents is “20 atomic %”. In this case, the variation σ in the reversal magnetic field is 5.5%.

### EXPERIMENTAL EXAMPLE NO. 4

NiFe is used as the ferromagnetic element and Zr is used as the nonmagnetic element. The Zr contents is “29 atomic %”. In this case, the variation σ in the reversal magnetic field is 6.0%.

### EXPERIMENTAL EXAMPLE NO. 5

NiFe is used as the ferromagnetic element and Ta is used as the nonmagnetic element. The Ta contents is “10 atomic %”. In this case, the variation σ in the reversal magnetic field is 6.0%.

### EXPERIMENTAL EXAMPLE NO. 6

NiFe is used as the ferromagnetic element and Ti is used as the nonmagnetic element. The Ti contents is “10 atomic %”. In this case, the variation σ in the reversal magnetic field is 6.5%.

### EXPERIMENTAL EXAMPLE NO. 7

NiFe is used as the ferromagnetic element and Hf, Ta are used as the nonmagnetic element. The Hf contents is “5 atomic %” and the Ta contents is “5 atomic %”. In this case, the variation σ in the reversal magnetic field is 6.3%.

### EXPERIMENTAL EXAMPLE NO. 8

NiFe is used as the ferromagnetic element and Nb, Zr are used as the nonmagnetic element. The Nb contents is “2 atomic %” and the Zr contents is “8 atomic %”. In this case, the variation a in the reversal magnetic field is 5.8%.

### EXPERIMENTAL EXAMPLE NO. 9

NiFe is used as the ferromagnetic element and W, Zr are used as the nonmagnetic element. The W contents is “5 atomic %” and the Zr contents is “10 atomic %”. In this case, the variation σ in the reversal magnetic field is 6.1%.

### EXPERIMENTAL EXAMPLE NO. 10

NiFe is used as the ferromagnetic element and Mo, Zr are used as the nonmagnetic element. The Mo contents is “5 atomic %” and the Zr contents is “10 atomic %”. In this case, the variation σ in the reversal magnetic field is 6.0%.

### EXPERIMENTAL EXAMPLE NO. 11

NiFeCo is used as the ferromagnetic element and Zr is used as the nonmagnetic element. The Zr contents is “10 atomic %”. In this case, the variation σ in the reversal magnetic field is 6.3%.

### COMPARATIVE EXAMPLE NO. 1

In this example, the free layer contains only NiFe and no other element is added (conventional technique). The Ni contents is “80 atomic %” and the Fe contents is “20 atomic %”. In this case, the variation a in the reversal magnetic field is 10.2%. As described above, according to the MRAM 100 of the present invention (The experimental examples No. 1 to No. 11), the variation a in the reversal magnetic field is reduced.

The reason why it is especially preferable that the variation σ in the reversal magnetic field is 10% or less is as follows. When a data is written to a memory cell, the spontaneous magnetization in a non-target memory cell may be reversed due to the write current. Such a phenomenon is called “disturb”. In a case of a memory cell array of 1 Mbit class, the disturb inevitably occurs if the variation a becomes equal to or more than 10%. It is generally known that the variation o needs to be lower than 10% in order to prevent the disturb. According to the present invention, as shown in FIG. 40, the variation σ reversal magnetic field less than 10% is achieved. Also, the element used here is selected from Ti, Zr, Nb, Hf, Ta, Mo and W. In this manner, the disturb is prevented and the yield is improved according to the present invention. It should be noted that there is a correlation between the variation σ in the reversal magnetic field and the surface roughness Ra. The fact that the variation σ is 10% or less is approximately consistent with the fact that the surface roughness Ra is 0.3 nm or less.

### COMPARATIVE EXAMPLE NO. 2

NiFe is used as the ferromagnetic element and Zr is used as the nonmagnetic element. The Zr contents is “4 atomic %”. In this case, the variation σ in the reversal magnetic field is 10.0%. As is obvious from a comparison between this comparative example No. 2 and the foregoing experimental example No. 1, it is desirable that the Zr contents is more than “4 atomic %”. In view of FIG. 6 and FIG. 7, it is preferable that the Zr contents is more than “15 atomic %”.

### COMPARATIVE EXAMPLE NO. 3

NiFe is used as the ferromagnetic element and Zr is used as the nonmagnetic element. The Zr contents is “31 atomic %”. In this case, the generated film does not exhibit the ferromagnetic property. As is obvious from a comparison between this comparative example No. 3 and the foregoing experimental example No. 4, it is desirable that the Zr contents is less than “30 atomic %” (refer to FIG. 5).

### COMPARATIVE EXAMPLE NO. 4

NiFeCo is used as the ferromagnetic element and Zr is used as the nonmagnetic element. The Zr contents is “4 atomic %”. In this case, the variation σ in the reversal magnetic field is 10.0%. As is obvious from a comparison between this comparative example No. 4 and the foregoing experimental example No. 11, it is preferable that the Zr contents is more than “5 atomic %”.

As described above, the ferromagnetic film (magnetic free layer) 33 according to the present invention has excellent evenness and thermotolerance. oreover, according to the TMR element 10 and the MRAM 100 of the present invention, the variation in the switching magnetic field is reduced. As a result, the operation margin is widened and the disturb is prevented. Therefore, the yield is improved.

(Method for Manufacturing)

Next, a method of manufacturing the magneto-resistance element 10 (magneto-resistance effect stacked film) according to the present invention will be described.

First, the lower electrode layer 21 is formed on the substrate 20. Subsequently, the base layer 22 is formed on the lower electrode layer 21, and the anti-ferromagnetic layer 23 is formed on the base layer 22. Next, the magnetic pinned layer 31 is formed on the anti-ferromagnetic layer 23. For example, the magnetic pinned layer 31 is formed by stacking a CoFe film with a thickness of 2.5 nm, a Ru film with a thickness of 0.8 nm and a CoFe film with a thickness of 2.5 nm in order. Subsequently, the tunnel insulating film (nonmagnetic layer) 32 is formed on the magnetic pinned layer 31. As the tunnel insulating film 32, for example, an AlO film with a thickness of 1 nm is formed.

Next, the magnetic free layer 33 is formed on the tunnel insulating film 32 through a well-known sputtering method. Here, the magnetic free layer 33 includes “first material” that is ferromagnetic and “second material” that is non-ferromagnetic. As described above, the first material includes at least one element selected from the group consisting of Fe, Co and Ni. For example, the first material is NiFe. Also, as described above, the second material includes at least one element selected from the group consisting of Zr, Ti, Nb, Ta, Hf, Mo and W. For example, the second material is Zr. It is preferable that the atomic percent of the second material is higher than “5 atomic %” and lower than “30 atomic %”.

Next, the upper electrode layer 24 is formed on the magnetic free layer 33. After some layers are further formed, a “heat treatment” is performed. By the heat treatment, the structure that the first portion 40 in which the concentration of the nonmagnetic element is low and the second portion 50 in which the concentration of the nonmagnetic element is high are separated is formed in the magnetic free layer 33. Here, the first portion 40 includes the first material as principal constituent, while the second portion 50 contains a high proportion of the second material. More specifically, the second layer) 32 is formed on the magnetic pinned layer 31. As the tunnel insulating film 32, for example, an AlO film with a thickness of 1 nm is formed.

Next, the magnetic free layer 33 is formed on the tunnel insulating film 32 through a well-known sputtering method. Here, the magnetic free layer 33 includes “first material” that is ferromagnetic and “second material” that is non-ferromagnetic. As described above, the first material includes at least one element selected from the group consisting of Fe, Co and Ni. For example, the first material is NiFe. Also, as described above, the second material includes at least one element selected from the group consisting of Zr, Ti, Nb, Ta, Hf, Mo and W. For example, the second material is Zr. It is preferable that the atomic percent of the second material is higher than “5 atomic %” and lower than “30 atomic %”.

Next, the upper electrode layer 24 is formed on the magnetic free layer 33. After some layers are further formed, a “heat treatment” is performed. By the heat treatment, the structure that the first portion 40 in which the concentration of the nonmagnetic element is low and the second portion 50 in which the concentration of the nonmagnetic element is high are separated is formed in the magnetic free layer 33. Here, the first portion 40 includes the first material as principal constituent, while the second portion 50 contains a high proportion of the second material. More specifically, the second portion 50 is formed by the second material being deposited at the grain boundary 60 of the first portion 40 that is crystalline (refer to FIG. 4A). In this manner, the heat treatment is performed such that the first portion 40 and the second portion 50 are separated from each other. When the heat treatment is performed under the further higher temperature, the deposition of the second material to the grain boundary 60 progresses and thereby the structure that the ferromagnetic portion 70 and the non-ferromagnetic portion 80 are phase separated is obtained (refer to FIG. 4B).

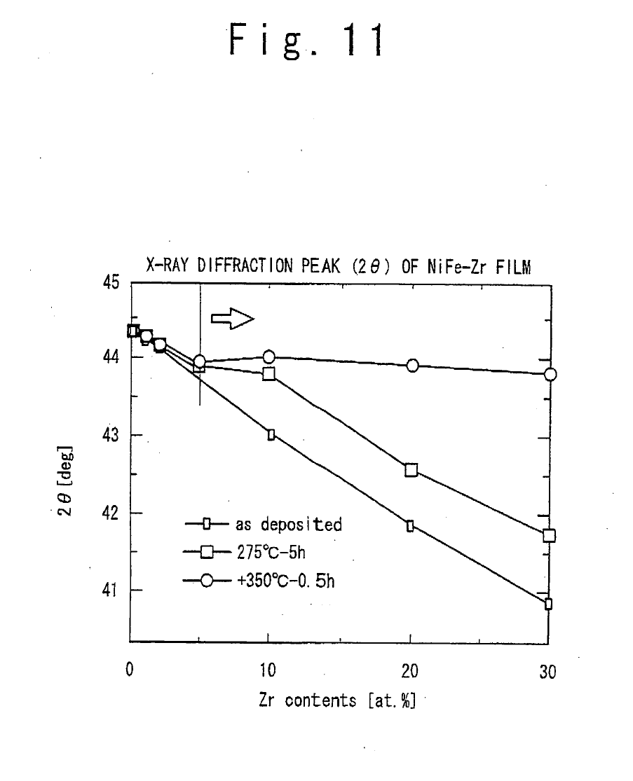

FIG. 11 is a graph for explaining a relation between the heat treatment temperature and the phase separation. FIG. 11 shows a case of NiFeZr film as an example. The ordinate axis represents the peak position 2θ of the X-ray diffraction and the abscissa axis represents the Zr contents. The Zr contents means contents of Zr with respect to the whole of the NiFeZr film. The peak position can be obtained from an X-ray diffraction experiment (θ-2θ measurement) with the use of Cu-Ka ray. The peak position 2θ is associated with a lattice constant of crystal. More specifically, decrease in the peak position 2θ means increase in the lattice constant, while increase in the peak position 2θ means decrease in the lattice constant. It should be noted in the present example that what appears by the X-ray diffraction is mainly a pattern associated with NiFe, and change in the peak position 2θ is considered to indicate change in the lattice constant of NiFe crystal. The information of the lattice constant of NiFe crystal can be also obtained by electron diffraction, as in the case of the X-ray diffraction. In the electron diffraction, a sample is flaked and then electron beam is transmitted. Since a thickness of the flake is about 30 nm, an average lattice constant can be obtained.

Shown in FIG. 11 are three kinds of states: a state before the heat treatment (as deposited) , a state after the heat treatment is performed under a temperature of 275 degrees centigrade for five hours, and a state after the heat treatment is performed under a temperature of 350 degrees centigrade for half an hour. First, the state before the heat treatment (as deposited) is a state of alloy in which the above-mentioned first material (NiFe) and the above-mentioned second material (Zr) are distributed homogeneously. In this case, there is a tendency that the peak position 2θ decreases almost monotonically as the Zr contents is increased. In other words, the lattice constant becomes larger as the Zr contents is increased. This is attributed to the fact that Zr comes to be mixed in the NiFe crystal and the NiFe crystal lattice is forced to be expanded.

Next, in the case when the heat treatment is performed under 275 degrees centigrade, it can be seen that the peak position 2θ is increased overall as compared with the state before the heat treatment. That is to say, the lattice constant is decreased as compared with the state before the heat treatment. This means that Zr is deposited at the grain boundary 60 due to the heat treatment and the NiFe crystal lattice is getting back the original one. That is to say, the second element (Zr) with a large atomic radius and of high-melting point is deposited at the grain boundary 60 and thus the lattice constant becomes small. The deposited Zr forms the second portion 50 in which the concentration of the nonmagnetic element is high. It should be noted that the peak position 2θ still decreases as the Zr contents is increased. Therefore, the first portion 40 is considered to include Zr to some extent.

Next, in the case when the heat treatment is performed under 350 degrees centigrade, it can be seen that the peak position 2θ is further increased overall as compared with the case when the heat treatment is performed under 275 degrees centigrade. That is to say, the lattice constant is further decreased. Moreover, it can be seen that the peak position 2θ is almost constant even when the Zr contents is increased. The constant value is about 44 degrees, which is about the same as a value in a case when the Zr contents is 0%. This means that almost all Zr is deposited at the grain boundary 60 and hence the crystal lattice of the NiFe crystal becomes almost the same as that of pure NiFe crystal. That is to say, it is considered that the phase separation progresses almost completely as a result of the heat treatment under the temperature of 350 degrees centigrade. Consequently, the ferromagnetic portion 70 and the non-ferromagnetic portion 80 that are phase separated almost completely are formed. Also, the formed non-ferromagnetic portion 80 may include a slight amount of Ni/Fe.

As described above, according to the method of manufacturing magneto-resistance element 10 of the present invention, the heat treatment is performed under a temperature of 270 degrees centigrade or higher. As a result, the first portion 40 in which the concentration of the nonmagnetic element is low and the second portion 50 in which the concentration of the nonmagnetic element is high are formed in the magnetic free layer 33. Moreover, in the case when the heat treatment is performed under 350 degrees centigrade, the ferromagnetic portion 70 and the non-ferromagnetic portion 80 that are phase separated almost completely are formed. These can be observed through the measurement of the peak position by the X-ray diffraction (or electron diffraction pattern), as shown in FIG. 11. That is, the separation state can be confirmed by observing a smaller lattice constant than the lattice constant in the state before the heat treatment (as deposited) in which the first material and the second material are distributed homogeneously. In order to progress the phase separation almost completely, it is preferable that the heat treatment is performed under a temperature of 350 degrees centigrade or higher. Also, an upper limit of the temperature during the heat treatment is about 500 degrees centigrade from a practical point of view.

By the above-described method for manufacturing, the ferromagnetic film (magnetic free layer) 33 with excellent evenness and thermotolerance can be obtained. By using such the magnetic free layer 33, it is possible to fabricate the MRAM 100 in which the variation in the switching magnetic field is reduced. According to such the MRAM, the operation margin is widened and the disturb is prevented. Therefore, the yield is improved.

1. A ferromagnetic film that includes ferromagnetic element and nonmagnetic element, comprising:
a first portion in which concentration of said nonmagnetic element is lower than an average concentration of said nonmagnetic element in said ferromagnetic film; and
a second portion in which concentration of said nonmagnetic element is higher than said average concentration,
wherein said nonmagnetic element includes at least one element selected from the group consisting of Zr, Ti, Nb, Ta, Hf, Mo and W.

2. The ferromagnetic film according to claim 1,
wherein said ferromagnetic element includes at least one element selected from the group consisting of Fe, Co and Ni.

3. The ferromagnetic film according to claim 1,
wherein said ferromagnetic film is crystalline and said second portion exists at a grain boundary.

4. The ferromagnetic film according to claim 3,
wherein said first portion is formed to have a columnar structure.

5. A ferromagnetic film comprising:
a ferromagnetic portion and a non-ferromagnetic portion that are phase separated,
wherein said non-ferromagnetic portion includes at least one element selected from the group consisting of Zr, Ti, Nb, Ta, Hf, Mo and W which are nonmagnetic elements.

6. The ferromagnetic film according to claim 5,
wherein principal constituent of said ferromagnetic portion includes at least one element selected from the group consisting of Fe, Co and Ni which are ferromagnetic elements.

7. The ferromagnetic film according to claim 5,
wherein said ferromagnetic portion is crystalline and said non-ferromagnetic portion exists at a grain boundary of said ferromagnetic portion.

8. The ferromagnetic film according to claim 7,
wherein said ferromagnetic portion is formed to have a columnar structure.

9. The ferromagnetic film according to claim 1, having a thicking of 1 to 20 nm.

10. The ferromagnetic film according to claim 1,
wherein an atomic percent of an average concentration of said nonmagnetic element in said ferromagnetic film is lower than 30%.

11. The ferromagnetic film according to claim 1,
wherein an atomic percent of an average concentration of said nonmagnetic element in said ferromagnetic film is higher than 5%.

12. The ferromagnetic film according to claim 1,
wherein a roughness average of a surface is equal to or less than 0.3 nm.

13. A ferromagnetic film including:
at least one first element selected from the group consisting of Fe, Co and Ni; and
at least one second element selected from the group consisting of Zr, Ti, Nb, Ta, Hf, Mo and W,
wherein a lattice constant is smaller than a lattice constant of an alloy in which said first element and said second element are distributed homogeneously.

14. The ferromagnetic film according to claim 13,
wherein said lattice constant is a value obtained from a peak position of an X-ray diffraction measurement of an electron diffraction pattern.

15. (canceled)

16. A magneto-resistance element comprising:
a magnetic free layer;
a magnetic pinned layer; and
a nonmagnetic layer sandwiched between said magnetic free layer and said magnetic pinned layer,
wherein said magnetic free layer has a ferromagnetic film including ferromagnetic element and nonmagnetic element,
wherein said ferromagnetic film includes:
a first portion in which concentration of said nonmagnetic element is lower than an average concentration of said nonmagnetic element in said ferromagnetic film; and
a second portion in which concentration of said nonmagnetic element is higher than said average concentration.

17. The magneto-resistance element according to claim 16,
wherein said ferromagnetic element is at least one element selected from the group consisting of Fe, Co and Ni, and
said nonmagnetic element is at least one element selected from the group consisting of Zr, Ti, Nb, Ta, Hf, Mo and W.

18. A magneto-resistance element comprising:
a magnetic free layer;
a magnetic pinned layer; and
a nonmagnetic layer sandwiched between said magnetic free layer and said magnetic pinned layer,
wherein said magnetic free layer includes a ferromagnetic portion and a non-ferromagnetic portion that are phase separated.

19. The magneto-resistance element according to claim 18,
wherein principal constituent of said ferromagnetic portion includes at least one element selected from the group consisting of Fe, Co and Ni, and
said non-ferromagnetic portion includes at least one element selected from the group consisting of Zr, Ti, Nb, Ta, Hf, Mo and W.

20. The magneto-resistance element according to claim 16,
wherein said nonmagnetic layer is a tunnel insulating film.

21-25. (canceled)
